(19) United States
(12) Patent Application Publication
(10) Pub. No.: US 2008/0249939 A1
(43) Pub. Date: Oct. 9, 2008

(54) Systems and Methods for Using Interactive Devices for Identification, Security, and Authentication

(76) Inventor: John W. Veenstra, Holton, MI (US)

Correspondence Address: MERCHANT & GOULD PC, P.O. BOX 2903, MINNEAPOLIS, MN, 55402-0903, US

(21) Appl. No.: 12/061,848

(22) Filed: Apr. 3, 2008

Related U.S. Application Data
(60) Provisional application No. 60/909,853, filed on Apr. 3, 2007.

(51) Int. Cl. G06Q 20/00

(52) U.S. Cl. 705/44

(57) ABSTRACT

A computer implemented method of using data from 1 or more physical devices to process business logic. The devices can comprise of things like a mobile phone or hand set, a cell phone system tower, a GPS satellite, cable systems set top box, a business machine like a merchant's credit card processing machine or a unique personal communication device. The data received from the different device(s) is analyzed by a server(s) to determine things like location, best practice, fraud, identification, secure data ownership, payment verification and the presence of a device owner's actual control of the physical device or a physical asset.

### BACKGROUND

As computers, computer networks, mobile networks, and security systems have become more and more automated, the risk of unauthorized control of either physical devices, such as a credit card or cell phone or data such as passwords, etc., has become more acute. Specifically, an unauthorized user can rapidly monetize a physical device or data by tapping into or possessing the passwords and secure data of devices that allows entry into an individual's database of financial, transactional, and personal information.

The movement of financial information and payment methods from hard copy to electronic devices has opened up the opportunity for billions of dollars of fraud. Further, the increased use of digital security in devices that historically had physical locking systems has created the opportunity for thieves to take physical possession of hard assets, confidential data, and the contents of those hard assets.

Some attempts to solve these problems have been made. For example, credit card companies have attempted to have merchants match the signature on a credit card with the presenter's identification. This system is inadequate in that this system of authenticating is dependent upon a third party merchant who may not follow the verification procedures.

### SUMMARY

The disclosure provided in the following pages describe examples of some embodiments of the invention. The designs, figures, and description are non-limiting examples of some embodiments of the invention. For example, the description of the system relates only to a description of some embodiments of the invention. Other embodiments of the system may or may not include the features disclosed herein. Moreover, disclosed advantages and benefits may apply to only some embodiments of the invention, and should not used to limit the disclosure.

In an embodiment where customer presents a credit card at a merchant's physical location for the payment of goods and services, the detection system receives merchant information, such as the merchant's location, and the like, from the merchant or merchant terminal. In addition, the system contacts the customer's Secure ID Device, such as the customer's cell phone, a GPS device, communication device, or the like, to determine the location of the customer's Secure ID Device. If the geographic locations of the merchant and the customer's Secure ID Device are in geographic proximity, the system determines that the user of the credit card is the owner of the credit card.

In another embodiment where the customer initiates a financial transaction and the credit card is not presented to a merchant, such as an online transaction, a telephone transaction, a cell phone transaction, and the like, the detection system uploads the IP address from the merchant's transactional database to determine the location of the customer for the transaction. In addition, the system contacts the customer's Secure ID Device, such as the customer's cell phone, a GPS device, communication device, or the like, to determine the location of the customer's Secure ID Device. If the location of the customer for the transaction and the location of the customer's Secure ID Device are in geographic proximity, the system determines that the user of the credit card is the owner of the credit card.

The above examples relate to fraud protection for credit card purchases. In other embodiments, the system can be used for fraud protection in any financial transaction using a variety of payment methods, both electronic and paper based such as checks, debit transactions, promissory payments, negotiable instruments, and the like.

In other embodiments, the detection system can be used for the protection of property, such as a home, a car, or the like, the safety of a person, or for targeted marketing.

### DESCRIPTION OF THE FIGURES

FIG. 1 shows an example system in which a payment instrument is located at a merchant's physical location.

FIG. 2 shows an example system in which a payment instrument is located at a physical location that is remote from a merchant's physical location.

### DETAILED DESCRIPTION

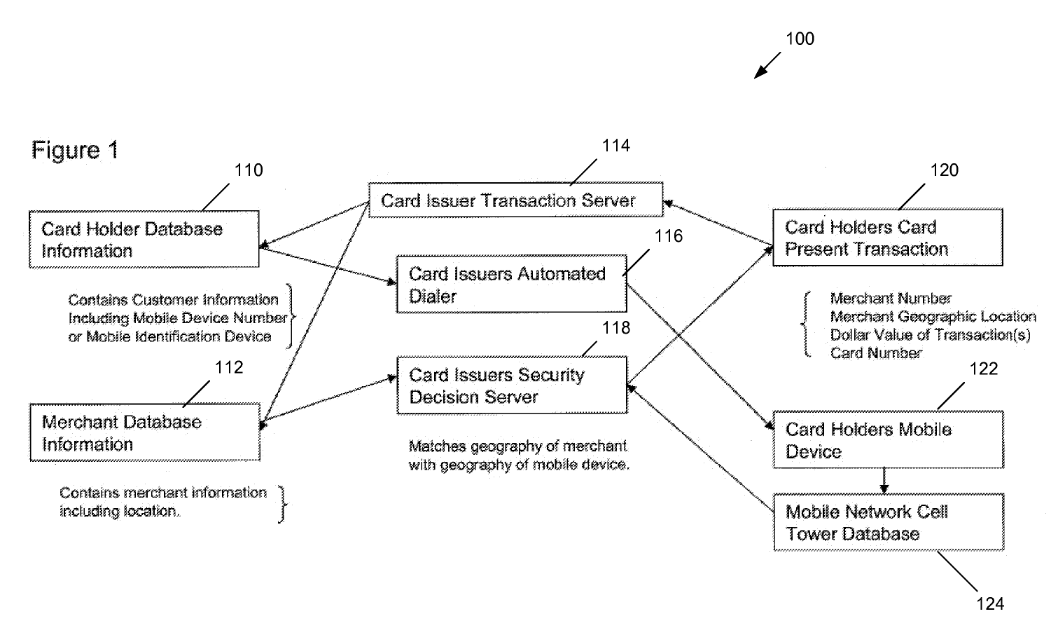

Referring now to FIG. 1, in one implementation, a credit card issuer uses a system 100 that uses a cell phone, mobile handheld or Secure ID Device 122 to verify transactions in payment processing on a server 114. In this embodiment, a card user presents a payment instrument, such as a credit card 120, at a physical location for the payment for services or products (i.e., a gas station). As part of the process, the card issuer's servers obtain the merchant's information comprising its geographic location. They also receive the card holder's information comprising credit qualifiers (e.g., mother's maiden name) and cell phone or Secure ID Device number. The card issuer's servers then use an automatic dialer machine 116 to place a call to the Secure ID Device associated with that card holders records 110 over a mobile network 124.

The call is used to “ping” the Secure ID Device 122 to define the geographic location of the tower closest to the Secure ID Device and thereby the location of the Secure ID Device. That geographic location of the Secure ID Device is then matched with the merchant's geographical location 112 as determined by the current transaction. If the geographies match, the issuer's servers 118 have used multiple physical devices, such as the merchant's card processor location and the card holder's Secure ID Device to insure that the individual presenting the card for that transaction is reasonably the actual owner of the card. If on the other hand, the geographies do not match, the card issuer has the option of initiating contact with the card owner via the Secure ID Device of record or simply denying the transaction.

If contact is made with the card holder of record and it is indeed a legal transaction, the card holder can be asked to type in the answer to certain credit qualifiers (such as mother's maiden name) as a way of insuring the legitimacy of the transaction. In an emergency, that would facilitate the mother giving her child the card to use when the mother could not physically be there. In a further embodiment, the Secure ID Device is associated with the customer's global positioning system device.

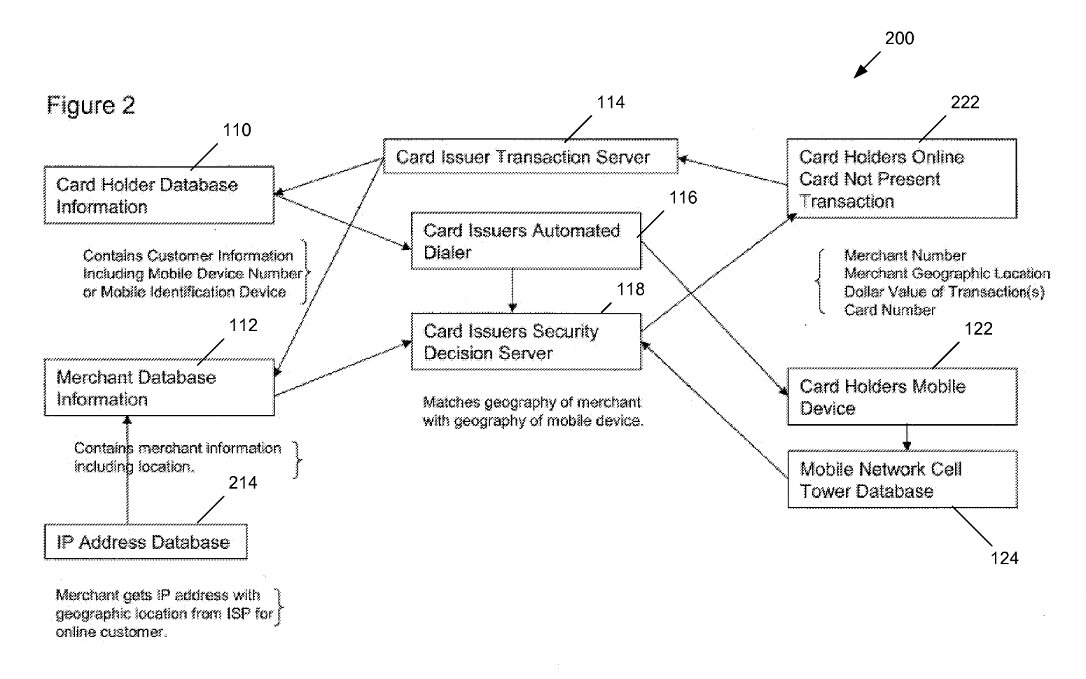

Referring now to FIG. 2, in another embodiment, a credit card issuer uses a system 200 to verify transactions in which the card 222 is not present at the merchant's physical location. Instead, the transaction is performed over a network such as the Internet. In this embodiment, the card issuer's servers 118 upload the IP address 214 from the merchant's transactional data base 212. The IP address contains the card user's physical location for that transaction.

The card issuer's servers now contain the card holder's financial data, geographical local, credit qualifiers, and registered Secure ID Device. A call (ping) is then made to the cardholder's Secure ID Device 122. As described above, the cell tower's geographic location is recorded in the issuer's servers and matched with the card holder's IP address associated with the current transaction. If the geographic locations are reasonably close, the transaction can be approved with a reasonable assurance there is no fraud. If the locations are not reasonably close, the issuer can proceed as described above. In a further embodiment, the Secure ID Device is associated with the customer's global positioning system device.

In another embodiment, an online interactive game server delivers content to a specific geographic location. As an individual online game player (gamer) progresses through the game, the gamer will see advertisements for things such as pizza. The game server has advertisers that want to get a coupon or an advertisement to that gamer. The gamer, if online, logs in under a specific IP location or a set of database information on that gamer is available. That information includes the gamer's geographic location.

Using technology described in U.S. Pat. No. 5,930,474, the entirety of which is hereby incorporated by reference, the game server can deliver a pizza coupon for a pizza store that is closest to the location of the gamer's CPU. However, in many instances the gamer may actually be using a mobile or hand held device to play the game and be in a different physical location than is registered in the database. In this embodiment, the online game server calls up the geographic location indicated in the gamer's data base profile along with the gamer's registered Secure ID Device number and ping the gamer's Secure ID Device to determine the gamer's actual geographic location.

The game server then matches the two locations. If the geographic locations are relatively the same, the coupon or advertisement is sent to the gamer's CPU. However, if the geographic locations were different, the coupons or advertisement could be re-formatted and sent to the gamer's mobile or hand held device for a more accurate and timely geographic match. Now the pizza coupon can be delivered to the gamer's mobile device that is physically close to the pizza shop handing out the coupon.

In another embodiment, the systems and methods described herein are used to insure the true owner's physical possession of an asset such as a car. In one example, a Secure ID Device is placed in a car. The Secure ID Device has no ring tone and automatically engages if called. If a car is stolen, the owner can dial the Secure ID Device in the car and activate a connection. The Secure ID Device's mobile network of towers then tracks the car's progress from geographic tower to geographic tower. The authorities are then able to locate the car. In another example, a car owner could install a Secure ID Device that is offline when the car is parked and automatically engages when the car is started. If the person starting the car is the owner, the owner can turn off the Secure ID Device by dialing the Secure ID Device from a handheld mobile device. If the car is stolen, the Secure ID Device stays connected and can be tracked tower to tower. In another example, a Secure ID Device is placed in a car and is automatically activated when the car starts. The Secure ID Device is set to shut the car engine off in five minutes if it does not receive the correct signal. If the owner is the one to start the car, the owner dials the Secure ID Device and the car continues to run.

In yet another embodiment, the system is used to provide a remote ID system for the protection of physical property, such as a house. The system sits on top of the normal home alarm system. However, instead of using key pads and typical alarm system hardware, which is subject to tampering, the sensors on doors and windows are connected to a dialer device to activate a response. If the system is triggered, the monitoring company does a database look-up of the Secure ID Device number of the home owner and dials the Secure ID Device. If it is the owner who has entered the house, the owner simply punches in a code on their Secure ID Device indicating that the owner had entered the house. Passwords and authentication can be requested to insure the integrity and control of the Secure ID Device. If the owner is not the one who has entered the house, the authorities can be summoned and respond. If a home owner is going to enter the house and does not want to trigger the alarm, the owner simply pushes the appropriate code on the Secure ID Device and no signal is sent to the alarm company when the door is opened.

In yet another embodiment, the system is used for the personal safety of an individual such as a child. A mobile Secure ID Device is placed on the possession of or under the skin of an individual. With a simple push of a button, a victim can have the Secure ID Device initiate contact with cellular system and be tracked geographically from tower to tower and trigger the 911 emergency systems.

In another embodiment, the system is used as a security system for computing devices and the devices content. The system uses an auto-dialer on a CPU or handheld that provides the network provider with the user's physical IP address and therefore the geographic location. In order to authenticate the user's ID, the network server goes into its database and finds the user's Secure ID Device number and initiates a ping. The Secure ID Device defines the geographic location of the CPU's legal owner. As described above, geographic match can be authorized and variances can be addressed.

In yet another embodiment, an individual carries a mobile device called a “Secure ID Device” (SIDD) whose function is to provide communication for authentication and tracking. The Secure ID Device differs from other handheld communication devices, in that it is a device whose number is made available to secure databases of companies such as credit card issuers, financial institutions, banks, credit rating bureaus, alarm services, personal security/tracking systems. It is carried by an individual. It can be worn much like a watch, in a belt or be placed under the skin. The Secure ID Device remotely connects to a server that has personal information related to the individual. The server can perform any number of business functions.

In the examples described herein, the systems and devices can include one or more computer systems including a processing unit and computer readable media. Computer readable media can include memory such as volatile (such as RAM), non-volatile (such as ROM, flash memory, etc.) or some combination thereof. The computer systems can also include mass storage (removable and/or non-removable) such as a magnetic or optical disks or tape. An operating system, such as Linux or Windows, and one or more application programs can be stored on the mass storage device. The computer systems can include input devices (such as a keyboard and mouse) and output devices (such as a monitor and printer). The computer systems can also include network connections to other devices, computers, networks, servers, etc. Other configurations are possible.

The various embodiments described above are provided by way of illustration only and should not be construed to limiting. Various modifications and changes can be made to the embodiments described above without departing from the true spirit and scope of the disclosure.

What is claimed is:

1. A system for verifying a financial transaction over a network, the system comprising:
a card verification module programmed to verify digits of a financial instrument used to purchase goods or services by an individual over the network;
a location module programmed to lookup a physical location associated with an IP address provided by the individual's computer;
a dialer module programmed to connect to the individual's mobile device to determine a physical location of the mobile device; and
a security module programmed to compare the physical location of the IP address with the physical location of the mobile device and to approve the transaction if the physical locations are in close proximity.
